(19) United States
(12) Patent Application Publication
(10) Pub. No.: US 2019/0079470 A1
(43) Pub. Date: Mar. 14, 2019

(54) METHOD OF GENERATING CONTROL COMMANDS FOR AN ELECTRONIC DEVICE BASED ON SIGNAL ACCUMULATION AMOUNT OF SENSORS

(71) Applicant: Simplo Technology Co., Ltd., Hsinchu County (TW)

(72) Inventors: Ming-Ta Chen, Hsinchu County (TW); Kuan-Cheng Chiu, Taipei City (TW)

(21) Appl. No.: 16/052,624

(22) Filed: Aug. 2, 2018

(30) Foreign Application Priority Data
Sep. 13, 2017 (TW) 106131429

(51) Int. Cl. G05B 13/04

(52) U.S. Cl. CPC G05B 13/04

(57) ABSTRACT

A method of generating control commands for an electronic device based on signal accumulation amount of sensors is provided in the invention. The method collects effective signal values using sensor(s) in the electronic device when physical quantities, generated or detected by the electronic device, change during the movement of the electronic device. As one or more effective signal values are accumulated to a certain amount that match the comparison with one activation mode or index parameter, the electronic devices then performs corresponding function accordingly.

### BACKGROUND OF THE INVENTION

### 1. Field of the Invention

The invention relates to a control method of an electronic device, and more particularly, to a method of generating control commands based on signal accumulation amount of sensors.

### 2. Description of the Prior Art

Digital devices or portable devices like digital cameras, smart phones, or tablet computers, or electronic devices like an ECG Holter, which is equipped with sensors of various types is operable to perform many default functions only through real buttons, switches, virtual buttons like touch on the screen, or voice activated control.

These methods of operation of prior art, however, are different from one another by nature and obviously each has its own drawbacks and limitation of use. For example:
1. Physical button or switch, which is composed by mechanical button or switch. Mechanical buttons have an average life of 50,000 clicks. However, for functions as photo taking using a digital camera or a smartphone that adapt vast amount of triggering, it is highly likely that the life of the button or switch will be shortened. Additionally, unintentional impact to the device may even cause failure of the mechanical button or switch.
2. Virtual button commonly realized in the form of touching a touch screen to activate corresponding functions such as taking a picture, video recording, or measuring . . . etc., which however takes too many steps to switch among functions and lacks instinctive operation modes.
3. Voice control to activate relevant functions of a device by recognition of the sounds from the human body, such as the vocal sound, clapping, or finger snapping. Generally, voice control is apt to be influenced by ambient noise and can lead to misinterpretation if the device is placed in a noisy circumstance. Besides, there are also some limitations as to where the control method can be adopted. For example, voice-activated photo shooting or video recording may be totally useless if it's about to take pictures of birds or, some strict noise restricted environment.

It is therefore an important and urgent issue needed to be taken care of to provide an intuitive operation method for digital device or electronic device adaptive to various circumstances.

### SUMMARY OF THE INVENTION

Embodiments of the invention therefore provide a method of generating control commands for an electronic device based on signal accumulation amount of sensors so that operation of digital devices or electronic devices can be more intuitive and adaptive for various scenarios.

An exemplary embodiment of the invention provides a method of generating control commands for an electronic device based on signal accumulation amount of sensors. The method includes following steps: storing a plurality of index parameters in an electronic device; at least one sensory element of the electronic device generating at least one signal variation curve, which is a curve of a signal value generated by the sensory element over time; obtaining at least one sensory index according to the signal variation curve and comparing the sensory index with one of the index parameters; setting the sensory index valid or invalid according to a comparison result of the sensory index with the index parameter; and the electronic device generating a corresponding control command according to a setting content of the sensory index.

The method of generating control commands for an electronic device based on signal accumulation amount of sensors provided in the invention is capable of equipping electronic devices with more diversified and easy operation experience, using concept of signal accumulation of one or more sensors as a basis to execute control commands. It also removes limitations and inconvenience of using physical buttons, touching the screen, or controlling with voice on the electronic devices.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a functional block illustration of an electronic device.

FIG. 2 is a schematic diagram showing a flow chart of method 100 of generating control commands for an electronic device based on signal accumulation amount of sensors.

FIG. 3 and FIG. 4 are schematic diagrams showing relation of the signal value over time of embodiments to detect the change of a certain physical quantity and generate a signal variation curve.

FIG. 5 is a schematic diagram showing the voltage variation of a pulse in ECG diagram.

FIG. 6A to FIG. 6C are schematic diagrams showing how the method of generating control commands for an electronic device may be implemented in another embodiment.

### DETAILED DESCRIPTION

Certain terms are used throughout the following description and claims to refer to particular system components. As one skilled in the art will appreciate, manufacturers may refer to a component by different names. In the following discussion and in the claims, the terms “include” and “comprise” are used in an open-ended fashion. Also, the term “couple” is intended to mean either an indirect or direct electrical/mechanical connection. Thus, if a first device is coupled to a second device, that connection may be through a direct electrical/mechanical connection, or through an indirect electrical/mechanical connection via other devices and connections.

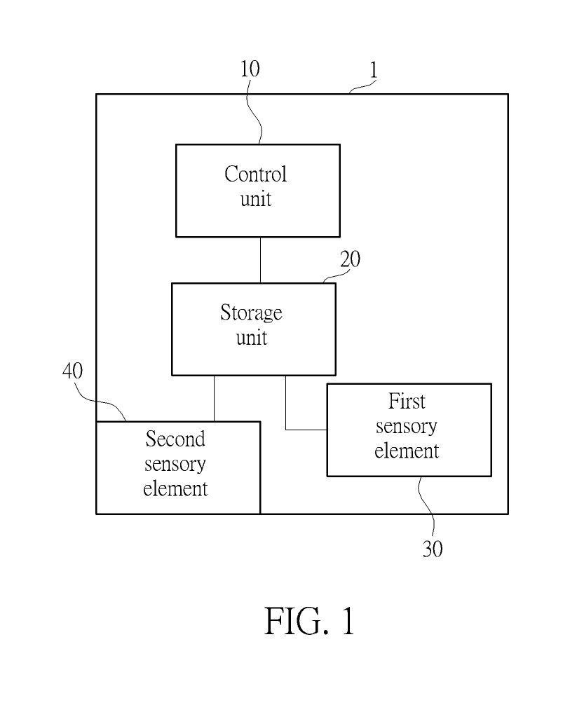

Please refer to FIG. 1. FIG. 1 is a functional block illustration of an electronic device. The electronic device 1 includes a control unit 10, a storage unit 20, a first sensory element 30, and a second sensory element 40. Within the scope of the invention, the electronic devices 1 can be digital devices or portable devices of any available types such as digital cameras, smart phones, or tablet computers, or electronic devices like an ECG Holter, which is equipped with sensors of various types. The storage unit 20 stores signals generated by sensory elements, e.g., the first sensory element 30, the second sensory element 40, or more, and stores data needed for processing of these signals, i.e., the index parameters described in the embodiments of the invention. The data stored will be processed, compared, and evaluated by the control unit 10 using the method provided in the embodiment of the invention before corresponding software or hardware functions is performed accordingly.

For example, given what functions and features the electronic device 1 is provided with, the first sensory element 30 and the second sensory element 40 can be sensors like 3-axis accelerometer, gyroscope, inertial accelerometer, photo diode, CCD or CMOS, capacitance sensor like a capacitance touch screen, inductance sensor, magnetic sensor . . . etc. The sensory elements can, based on the change of physical status of the electronic device 1, generate corresponding self-generated physical quantity such as linear acceleration variation, rotational acceleration variation, voltage variation intrigued by capacitance variation, voltage variation intrigued by inductance variation . . . etc., or based on the ambient state of environment where the electronic device 1 is located, generate corresponding ambient physical quantity such as magnetic field variation, color variation of image, light intensity variation, temperature variation . . . etc. Take digital camera or smartphone with picturing function as an example of the electronic device 1, one or more sensors generate signals and the variation of signal can be used to perform picture-related functions such as entering standby or sleep mode, taking a picture, video recording, time-lapse recording, focusing, zooming in or out . . . etc.; as a mobile communication device, one or more sensors generate signals and the variation of signal can be used to perform related functions such as entering standby mode, opening one or more Apps, awaking the screen, answering a call, hanging out a call, etc.; as a dedicated measurement equipment like a ECG Holter, functions like taking the ECG, awaking, shutting down . . . can be performed using the method in the invention.

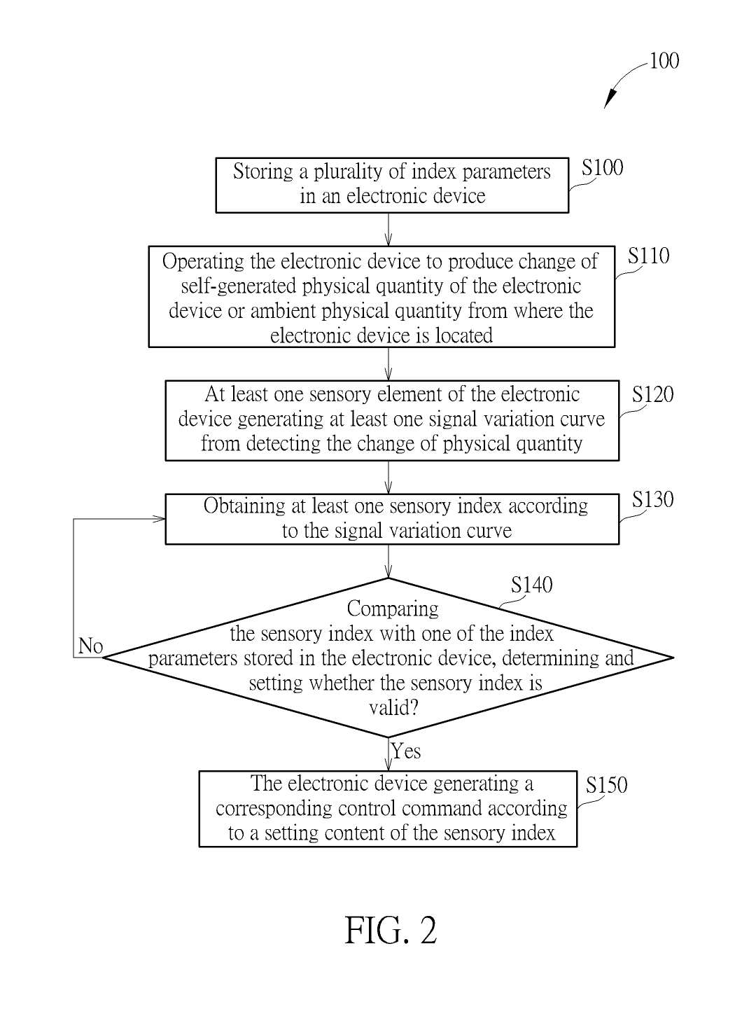

Please refer to FIG. 2, which is a schematic diagram showing a flow chart of method 100 of generating control commands for an electronic device based on signal accumulation amount of sensors, which includes following steps:

Step S100: storing a plurality of index parameters in an electronic device;

Step S110: operating the electronic device so as to produce change of self-generated physical quantity of the electronic device or ambient physical quantity from where the electronic device is located;

Step S120: at least one sensory element of the electronic device generating at least one signal variation curve from detecting the change of physical quantity;

Step S130: obtaining at least one sensory index according to the signal variation curve;

Step S140: comparing the sensory index with one of the index parameters stored in the electronic device and setting whether the sensory index is valid or not?

Step S150: the electronic device generating a corresponding control command according to a setting content of the sensory index.

In the embodiments of the invention, decisions for executing corresponding control commands are made from the result of analysis of the magnitude and lasting time of signals generated by the movement of the electronic device 1, i.e., the accumulation of signal magnitude with respect to time, as a form of ‘carried-out energy accumulation’ of the movement. In other words, the control method of the invention is effective in obtaining the required input information whether the input is a long term, low strength signal or a constantly-changing strength signal within a specific period of time. In Step S100, a plurality of index parameters is pre-stored in the storage unit 20 of the electronic device 1. Each of the index parameters (model) corresponds to a control command and the index parameters are built from the concept of area.

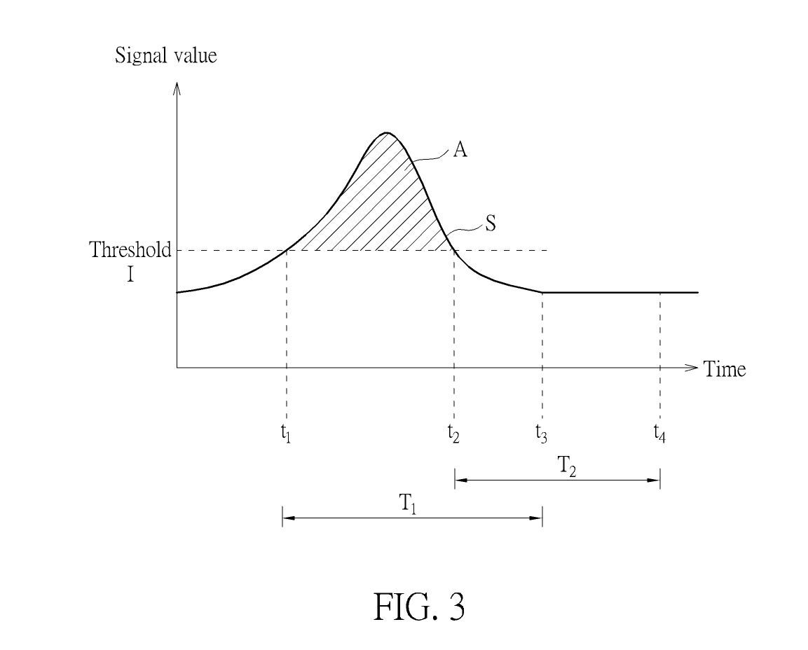

It should be noted that in the description of the invention, the term ‘index’ may be interpreted as an alternative way of describing the concept ‘area’ or as a result converted from the physical quantity ‘area,’ which is obtained by integration of the magnitude with respect to time in a 2-D magnitude-time chart of signal and comes with no specific unit for such index (index parameter or sensory index). Please refer to FIG. 3 as an example. The area A integrated from an acceleration variation generated by a 3-axis accelerometer with respect to time can be presented as an index; likewise, as an example in other embodiment, the area integrated from a voltage signal magnitude of a CCD with respect to time or the area integrated from an angular velocity variation of a gyroscope with respect to time can both be presented as indexes as well.

When the electronic device 1 is operated so that certain physical quantities vary accordingly as in Step S110, the sensory elements in the electronic device 1 are able to detect the change of the physical quantities and generate at least one signal variation curve, which is a curve of a signal value generated by the sensory element over time (Step S120). At least a sensory area can be obtained from the at least one signal variation curve generated by the sensory element and such sensory area is presented as a sensory index (Step S130, detailed in the following paragraphs). For electronic device 1 that has sensory elements, e.g., 3-axis accelerometer, gyroscope, inertial accelerometer . . . , capable of detecting movements of the electronic device 1 and that comes with the ability to demonstrate different types of movements for the sensory elements to generate various types of signal variation curves, patterns of variation related to signal value over time for different sensory element vary and at least one sensory index can be obtained therefrom. These sensory indexes are used for comparison with each corresponding index parameter stored in the storage unit 20 (Step S140). When one sensory index obtained from a signal variation curve is compared with some specific index parameter and has a certain relation with the index parameter, e.g., for one embodiment of the invention, the sensory index has accumulated enough ‘energy of execution’, and then the sensory index is set to be valid as in Step S140. Finally, combination or set content of one or many sensory indexes is used to generate a corresponding control command for performing a function on the electronic device 1. Besides, Steps S130˜S150 are carried out by the control unit 10 in FIG. 1.

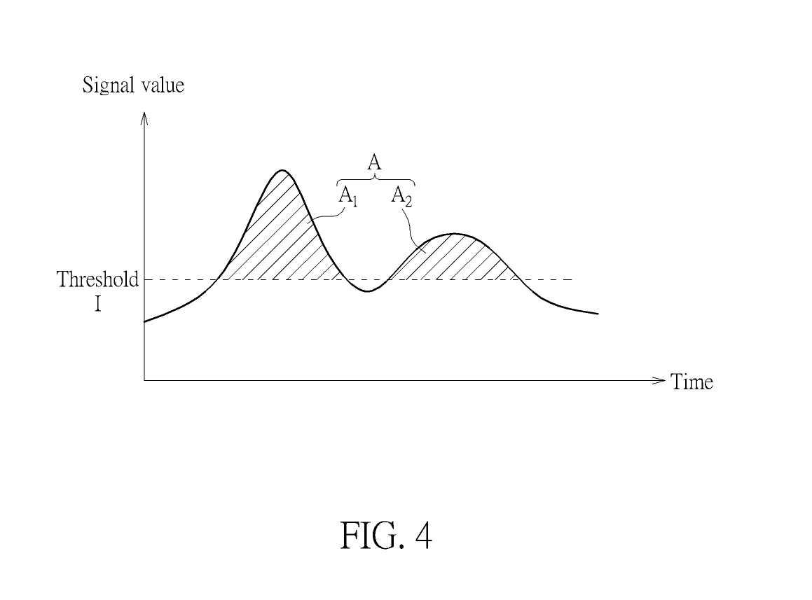

Please refer to FIG. 3 and FIG. 4. FIG. 3 is a schematic diagram showing a relation of the signal value over time of an embodiment when performing Step S120 to detect the change of a certain physical quantity and generate a signal variation curve. FIG. 4 is a schematic diagram showing another embodiment of the signal value over time. The sensory element in FIG. 3 can be the first sensory element 30 or the second sensory element 40 of the electronic device 1 in FIG. 1 and as aforementioned a sensor capable of sensing some specific physical quantity according to the functions and features the electronic device 1 has.

To stay away from being interfered by noise when implementing the method 100 of the invention, it can be put into practice that the signal value will be, under the control of the control unit 10, counted into the sensory area only when the signal value of the signal variation curve S is greater than a threshold I as the sensory element is generating the signal variation curve S and the at least one sensory area is obtained accordingly. It can be learned from FIG. 3 that a sensory area A is defined to be the area with slash lines between time t1 and time t2. Please be noted that the accumulation of the sensory area A begins at time t1, which is when the signal value of the signal variation curve S turns greater than the threshold I. Besides the exemplary embodiment illustrated in FIG. 3, another embodiment shown in FIG. 4 indicates that the sensory area A may also include a plurality of discontinuous sensory areas, which in this case, a sensory area A1 and a sensory area A2. That is, it is possible that the signal value of the signal variation curve S may be greater than the threshold I at some time and less than the threshold I at another time within a certain period of time. A movement of the electronic device 1 in real world may present to be moving fast and slow intermittently, taking the accelerometer as the sensory element, in which the acceleration happens to be greater than the threshold I for several time periods. In such case, both the sensory area A1 and the sensory area A2, or even still other discontinuous sensory areas, will be counted into the sensory area A as in Step S130. For embodiment either in FIG. 3 or in FIG. 4, the sensory area A is obtained from the signal variation curve S and is presented as sensory index without unit.

Next in Step S140, the sensory index obtained from the accumulated sensory area A, which is a constantly accumulated value beginning from time t1, is compared with a specific index parameter. In an embodiment, the sensory index will be set valid (an effective index) and the accumulation of the sensory area A stops when the value of the sensory index is larger than or equal to the index parameter. In another embodiment, each index parameter may also use a tolerance interval and the sensory index can be set valid only when the value of the sensory index falls within the tolerance interval of the index parameter, which in other words implies the electronic device 1 is under proper operation instead of being excessively operated.

Please keep referring to FIG. 3 and FIG. 4. The above embodiment shows that the time t1 as a beginning time to accumulate the sensory area A is the time when the signal value of some signal variation curve begins to exceed the threshold I. As for those accumulations of sensory index obtained from the sensory area A hasn't been able to meet the comparison condition with the index parameter, in one embodiment, the accumulation may be stopped (which means the signal variation curse S for this time is abandoned) at time t3, which is in a first predetermined time T1 after the time when the sensory index begins to accumulate (time t1), or the accumulation may also be stopped at time t2, which is a time when the sensory area A begun to accumulate at time t1 and afterwards the signal value of the signal variation curve S begun to fall below (smaller than) the threshold I and last for a second predetermined time T2. A possible movement of the electronic device 1 in real world may present to be having one or many times of ‘meaningful’ movements but the overall extent of movement still fails to get to the required level. So, no control command will be generated for this time interval.

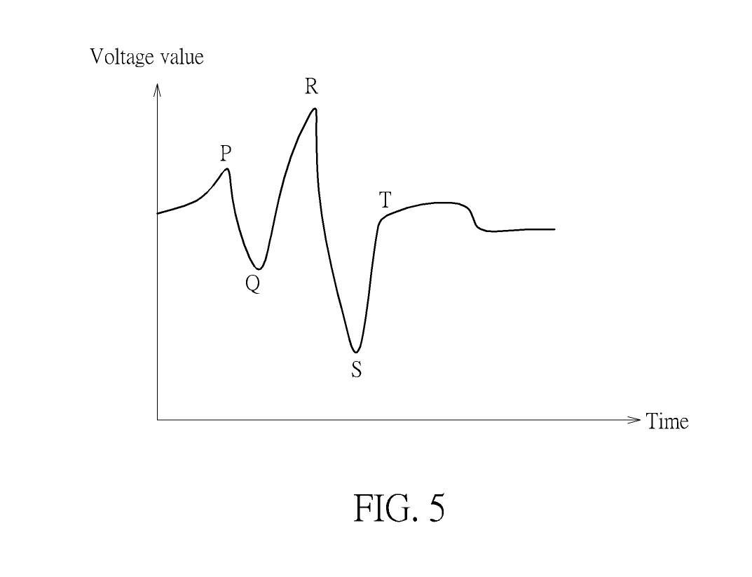

Each of the plurality of index parameters stored in the storage unit 20 in the above embodiments represents a value related to a physical quantity, i.e., the corresponding index parameter representing the variation of displacement acceleration for the first sensory element 30 in FIG. 1 taken as an accelerometer and the corresponding index parameter representing the variation of rotational acceleration for the second sensory element 40 in FIG. 1 taken as a rotational accelerometer. In other embodiments, each of the plurality of index parameters stored in the storage unit 20 may also represent a characteristic signal segment of a same physical quantity where one characteristic signal segment is not totally overlapping with another characteristic signal segment. Please refer to FIG. 5. FIG. 5 is a schematic diagram showing the voltage variation of a pulse in ECG diagram.

When the electronic device 1 is an ECG Holter, the signal variation curve generated by the sensory element is known as a specific section of ECG pulse signal. FIG. 5 shows that a typical ECG pulse signal may consist of a variety of different characteristic signal segments like the PQ segment, the QR segment, the RS segment, and the ST segment (or the PR segment, the RT segment, etc.). For an embodiment with multiple characteristic signal segments from a same physical quantity, the method 100 is applicable to compare the signal variation curve generated by the electronic device 1, e.g., the signal variation curve of the QR segment from the measured ECG pulse signal, with the stored index parameter for QR segment in the storage unit 20 and determine whether the sensory index of the QR segment is valid or not. Finally in Step S140, when some sensory index is set to be valid, the electronic device 1 generates corresponding control command.

A number of examples are provided below as exemplary embodiments, but not limited to, of the invention:

1. Light Intensity Variation:

The sensory element of the electronic device 1 may be a photo diode, which generates corresponding voltage values based on the intensity of light source when exposed in an ambient light. The stronger the intensity, the greater the voltage generated. A sensory area can be obtained from a variation curve of voltage value over time.

Take the electronic device 1 for a digital camera as an example. When a digital camera moves from a dark environment to a bright environment, e.g., picking up the digital camera from the table, the photo diode in the digital camera senses changes of light, thereby causing variation of outputted voltage. When the sensory index, corresponding to the sensory area obtained from the variation curve of voltage value over time, exceeds a predetermined value, the digital camera then executes a control command: restoring from standby mode.

For the electronic device 1 as an ECG Holter, when an ECG Holter moves from a light environment to a dark environment, e.g., an ECG Holter user puts up clothe that covers the ECG Holter, the photo diode in the ECG Holter senses changes of light, thereby causing variation of outputted voltage. When the sensory index, corresponding to the sensory area obtained from the variation curve of voltage value over time, exceeds a predetermined value, the ECG Holter then executes a control command: measuring the ECG value.

2. Color Detection:

The sensory element of the electronic device 1 may be a CCD or CMOS, which accumulates charges of different colors when receiving lights from an image. As some color received is increased in proportion, the voltage of the CCD or CMOS with respect to the color also increases. A sensory area can be obtained from a variation curve of voltage value over time.

Take the electronic device 1 for a digital camera as an example. When a digital camera moves to a red dominant environment, the ‘red component’ of the CCD or the CMOS has voltage rise accordingly. When the sensory index, corresponding to the sensory area obtained from the variation curve of voltage value over time, exceeds a predetermined value, the digital camera then executes a control command: taking a picture.

For the electronic device 1 as an ECG Holter, when an ECG Holter moves to a red dominant environment, the ‘red component’ of the CCD or the CMOS has voltage rise accordingly. When the sensory index, corresponding to the sensory area obtained from the variation curve of voltage value over time, exceeds a predetermined value, the ECG Holter then executes a control command: measuring the ECG value.

3. Capacitance:

The sensory element of the electronic device 1 is a capacitance sensor like a capacitance touch screen. When a dielectric, i.e., a finger, comes close to the capacitance sensor, there will be voltage accumulation within the capacitance sensor such that the voltage read by the capacitance sensor rises. A sensory area can be obtained from a variation curve of voltage variation over time.

Take the electronic device 1 for a digital camera as an example. When a finger gets close to the capacitance sensor on the screen and when the finger stays within a distance or contacts the screen for as long as required, the voltage outputted by the capacitance sensor rises accordingly. When the sensory index, corresponding to the sensory area obtained from the variation curve of voltage value over time, exceeds a predetermined value, the digital camera then executes a control command: turning off.

For the electronic device 1 as an ECG Holter, when a finger gets close to the capacitance sensor of the ECG Holter and when the finger stays within a distance or contacts the sensor for as long as required, the voltage outputted by the capacitance sensor rises accordingly. When the sensory index, corresponding to the sensory area obtained from the variation curve of voltage value over time, exceeds a predetermined value, the ECG Holter then executes a control command: turning off.

4. Inductance:

The sensory element of the electronic device 1 is an inductance sensor. When electric current flowing through the inductance sensor varies, voltage value will be generated accordingly by the inductance sensor based on the degree of current variation. A sensory area can be obtained from a variation curve of voltage variation over time.

Take the electronic device 1 for a digital camera as an example. If a surge of charging current occurs during the charging process perhaps caused by an abnormity of charging system, the inductance sensor acts accordingly to output a rising voltage value. When the sensory index, corresponding to the sensory area obtained from the variation curve of voltage value over time, exceeds a predetermined value, the digital camera then executes a control command: cutting off the power.

5. Magnetic Force:

The sensory element of the electronic device 1 is a magnetic sensor. When getting close to a magnet, the magnetic sensor generates current accordingly. A sensory area can be obtained from a variation curve of current variation over time.

Take the electronic device 1 for a digital camera as an example. When mounted to a fastening device with a magnet, the magnetic sensor of the digital camera detects a stronger magnetic field, thereby generating a larger voltage. When the sensory index, corresponding to the sensory area obtained from the variation curve of voltage value over time, exceeds a predetermined value, the digital camera then executes a control command: video recording.

For the electronic device 1 as an ECG Holter, when a lead of the ECG Holter with the magnetic sensor is placed at a base with a magnet, the magnetic sensor detects a stronger magnetic field, thereby generating a larger voltage. When the sensory index, corresponding to the sensory area obtained from the variation curve of voltage value over time, exceeds a predetermined value, the ECG Holter then executes a control command: awaking.

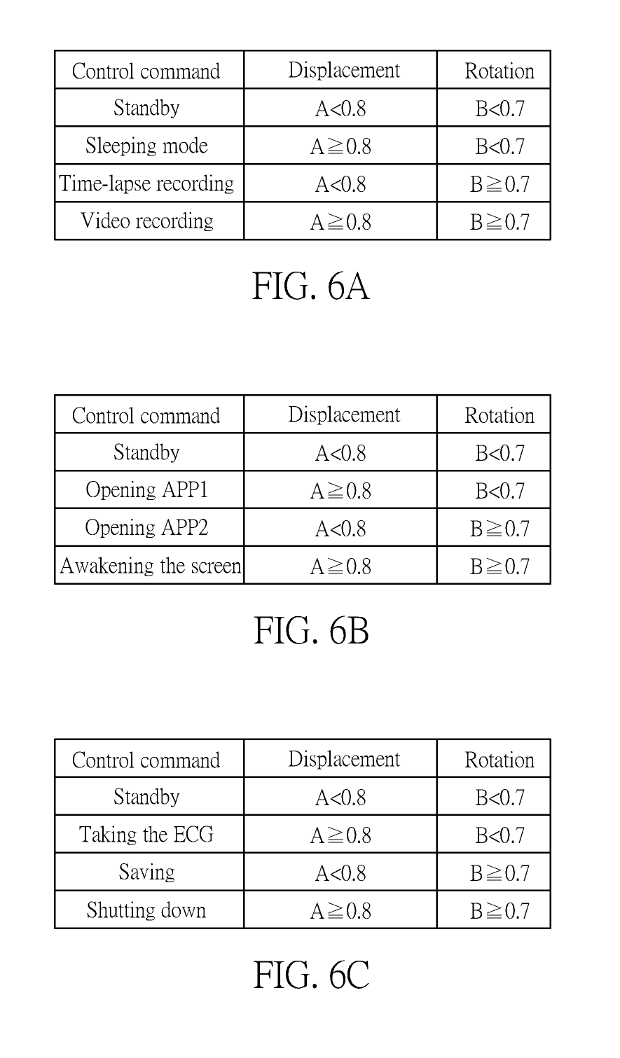

Please refer to FIG. 6A to FIG. 6C, which are schematic diagrams showing how the method of generating control commands for an electronic device may be implemented in another embodiment. The above embodiments use one index parameter to compare with a physical quantity detected by one sensory element and with which result a corresponding control command is executed based on the set result of the sensory index. In other embodiments, however, two or more physical quantities may be included and detected such that the electronic device may have much diversified combination of control commands. Please also refer to FIG. 1. For example, the plurality of index parameters stored in the storage unit 20 of the electronic device 1 may include at least a first index parameter and a second index parameter. The first sensory element 30 of the electronic device 1, 3-axis accelerometer for example, generates a first signal variation curve when the electronic device 1 performs a linear acceleration in the space. The second sensory element 40 of the electronic device 1, rotational accelerometer for example, generates a second signal variation curve when the electronic device 1 performs a rotational movement in the space. The control unit 10 takes into account data from both the first signal variation curve and the second signal variation curve. At least a first sensory index is obtained from the first signal variation curve and at least a second sensory index is obtained from the second signal variation curve. The way how the sensory indexes are obtained is similar as in those embodiments described above. The control unit 10 then compares the first sensory index with the first index parameter and compares the second sensory index with the second index parameter using the method provided in the embodiments aforementioned, by which the first sensory index and the second sensory index will be set valid or invalid according to the comparison result. In FIG. 6A˜6C, two indexes are used to determine whether or not to execute some control command, which will be 2×2=4 possible control commands with the valid/invalid combination of the two indexes. For example, referring to FIG. 6A˜6C and given the displacement related index parameter stored in the storage unit 20 is 0.8, when the accumulated value of a sensory index A obtained from the ‘linear’ signal variation curve is larger than or equal to 0.8, the sensory index A will be set as valid; when the accumulated value of the sensory index A is less than 0.8, the sensory index A will be set as invalid. Likewise, given the rotation related index parameter stored in the storage unit 20 is 0.7, when the accumulated value of a sensory index B obtained from the ‘rotational’ signal variation curve is larger than or equal to 0.7, the sensory index B will be set as valid; when the accumulated value of the sensory index B is less than 0.7, the sensory index A will be set as invalid.

FIG. 6A depicts an embodiment of power management, indicating generation of control commands of a sports camera including controlling the sports camera to enter a standby mode, a sleeping mode, to perform time-lapse recording, and normal video recording. When both the sensory index A and the sensory index B are set invalid, indicating the electronic device 1 fails to accumulate enough signals both in displacement and rotation. As such, the control command generated by the electronic device 1 accordingly will be ‘entering the standby mode’. When the sensory index A is set valid and the sensory index B is set invalid, indicating the electronic device 1 has accumulated enough signals in displacement (acceleration) but fails to accumulate enough signals in rotation. As such, the control command generated by the electronic device 1 accordingly will be ‘entering the sleeping mode’. When the sensory index A is set invalid and the sensory index B is set valid, indicating the electronic device 1 fails to accumulate enough signals in displacement but has accumulated enough signals in rotation (acceleration). As such, the control command generated by the electronic device 1 accordingly will be ‘performing time-lapse recording’. When both the sensory index A and the sensory index B are set valid, indicating the electronic device 1 have accumulated enough signals both in displacement and rotation. As such, the control command generated by the electronic device 1 accordingly will be ‘performing the video recording’. Please be noted that the control commands described above are presented, but not limited to, as an embodiment of realizing power management for a device by using the method of the invention.

FIG. 6B depicts an embodiment of activation mechanism of a remote device. For example, the electronic device 1 may be a no-body-attached device like a smart phone and control commands are generated from the set content of combination of the sensory index A and the sensory index B, which is operated in similar meaning as what is shown in FIG. 6A. FIG. 6C depicts an embodiment of activation mechanism of a near end device. For example, the electronic device 1 may be a body-attached device like an ECG Holter and control commands are generated from the combination of the sensory index A and the sensory index B, which is operated in similar meaning as what is shown in FIG. 6A and FIG. 6B. For other embodiments of the invention, there can even be three or more signal sources for determining the execution of control commands that utilize the method provided from the above embodiments.

The method of generating control commands for the electronic device based on signal accumulation amount of sensors according to the embodiments of the invention collects effective signal values using sensor(s) in the electronic device when physical quantities, generated or detected by the electronic device, change during the movement of the electronic device. As one or more effective signal values are accumulated to a certain amount that match the comparison with one activation mode or index parameter, the electronic devices then performs corresponding function accordingly. Two or more types of signal values from one or more sensors may also be used as a comparison basis so as to provide combinational result able to execute control command correspondingly.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of generating control commands for an electronic device based on signal accumulation amount of sensors, comprising steps:
storing a plurality of index parameters in an electronic device;
at least one sensory element of the electronic device generating at least one signal variation curve, which is a curve of a signal value generated by the sensory element over time;
obtaining at least one sensory index according to the signal variation curve and comparing the sensory index with one of the index parameters;
setting the sensory index valid or invalid according to a comparison result of the sensory index with the index parameter; and
the electronic device generating a corresponding control command according to a setting content of the sensory index.

2. The method of claim 1, wherein the sensory element generates the signal variation curve according to a self-generated physical quantity of the electronic device, the self-generated physical quantity of the electronic device comprising one of the following: linear acceleration variation, rotational acceleration variation, voltage variation intrigued by capacitance variation, voltage variation intrigued by inductance variation; wherein the sensory element is a corresponding sensor capable of measuring the self-generated physical quantity of the electronic device.

3. The method of claim 1, wherein the sensory element generates the signal variation curve according to an ambient physical quantity from where the electronic device is located, the ambient physical quantity from where the electronic device is located comprising one of the following: magnetic field variation, color variation of image, light intensity variation, temperature variation; wherein the sensory element is a corresponding sensor capable of measuring the ambient physical quantity from where the electronic device is located.

4. The method of claim 1, wherein obtaining at least one sensory index according to the signal variation curve and comparing the sensory index with one of the index parameters comprising:
obtaining the sensory index according to the signal variation curve when the signal value of the signal variation curve is greater than a threshold;
wherein the at least one sensory index comprises one or a plurality of discontinuous sensory indexes.

5. The method of claim 1, wherein obtaining at least one sensory index according to the signal variation curve and comparing the sensory index with one of the index parameters comprising:
beginning accumulation the sensory index when the signal value of the signal variation curve is greater than a threshold and stopping accumulation of the sensory index after the sensory index is set valid according to the comparison result of the sensory index with the index parameter.

6. The method of claim 1, wherein obtaining at least one sensory index according to the signal variation curve and comparing the sensory index with one of the index parameters comprising:
beginning accumulation of the sensory index when the signal value of the signal variation curve is greater than a threshold; and
stopping accumulation of the sensory index in a first predetermine time after the sensory index begins to accumulate, or stopping accumulation of the sensory index when the signal value of the signal variation curve being smaller than the threshold lasts for a second predetermined time.

7. The method of claim 1, wherein setting the sensory index valid or invalid according to the comparison result of the sensory index with the index parameter comprising:
setting the sensory index valid when the sensory index is greater than or equal to the index parameter.

8. The method of claim 1, wherein each of the plurality of index parameters has a tolerance interval and setting the sensory index valid or invalid according to the comparison result of the sensory index with the index parameter comprises:
setting the sensory index valid when the value of the sensory index falls within the tolerance interval of the index parameter.

9. The method of claim 1, wherein each of the plurality of index parameters stored in the electronic device represents a characteristic signal segment of a same physical quantity where one characteristic signal segment is not totally overlapping with another characteristic signal segment, and wherein setting the sensory index valid or invalid according to the comparison result of the sensory index with the index parameter comprises:
setting the sensory index valid when the sensory index is greater than or equal to the index parameter.

10. The method of claim 1, wherein each of the plurality of index parameters stored in the electronic device represents a characteristic signal segment of a same physical quantity where one characteristic signal segment is not totally overlapping with another characteristic signal segment and each of the plurality of index parameters has a tolerance interval, and wherein setting the sensory index valid or invalid according to the comparison result of the sensory index with the index parameter comprises:
setting the sensory index valid when the value of the sensory index falls within the tolerance interval of the index parameter.

11. The method of claim 1, wherein the plurality of index parameters comprises a first index parameter and a second index parameter, the method comprising:
a first sensory element of the electronic device generating a first signal variation curve and a second sensory element of the electronic device generating a second signal variation curve;
obtaining a first sensory index according to the first signal variation curve, obtaining a second sensory index according to the second signal variation curve, comparing the first sensory index with the first index parameter, and comparing the second sensory index with the second index parameter; and
setting the first sensory index valid or invalid according to a comparison result of the first sensory index with the first index parameter, and setting the second sensory index valid or invalid according to a comparison result of the second sensory index with the second index parameter.

12. The method of claim 11, further comprising step:
the electronic device generating the corresponding control command according to a combination of setting content of the first sensory index and the second sensory index.
